(19) United States
(12) Patent Application Publication
(10) Pub. No.: US 2026/0220726 A1
(43) Pub. Date: Jul. 30, 2026

(54) A SYSTEM OF INTELLIGENT PATENT TYPE RECOMMENDATION AND DRAFT GENERATION AND THE METHOD THEREOF

(71) Applicants: PENG-CHUN WU, Taipei City (TW); EN-PING LU, Taipei City (TW); YU-JUI CHANG, Taipei City (TW); VINCENT CHEN, Taipei City (TW)

(72) Inventors: PENG-CHUN WU, Taipei City (TW); EN-PING LU, Taipei City (TW); YU-JUI CHANG, Taipei City (TW); VINCENT CHEN, Taipei City (TW)

(21) Appl. No.: 19/148,920

(22) PCT Filed: Jan. 17, 2024
(86) PCT No.: PCT/US2024/011888

§ 371 Date: Jul. 17, 2025

Related U.S. Application Data
(60) Provisional application No. 63/439,320, filed on Jan. 17, 2023.

(51) Int. Cl. G06Q 50/18; G06F 16/28

(52) U.S. Cl. CPC G06Q 50/184; G06F 16/285; G06F 2216/11

(57) ABSTRACT

The present invention provides a system and method for intelligent patent type recommendation and draft generation, which is implemented by providing a user-operated electronic device, wherein the electronic device comprises a processor and a network interface controller, a server comprises an application, and the processor connects to the server through the network interface controller to execute the application for the purpose of recommending intellectual property application types, patent types, and draft generation.

### TECHNICAL FIELD

This invention relates to a system and method for intelligent recommendation and draft generation, especially the system and method for generating the patent type to be recommended for application, as well as the system and method for generating diagrams such as schematic diagrams, block diagrams, and flow charts in the draft.

### BACKGROUND OF THE INVENTION

In the traditional patent application process, whether domestic or foreign, it is necessary to print out paper documents and fill in a large number of forms. Many of these documents are paper-based, which can be a major inconvenience for management and classification. In addition to traditional paperwork, if communication is required between people during the patent application process, due to their different professional backgrounds, different language usage, cultural differences, and other unpredictable factors, inaccurate or misunderstood information may be conveyed, leading to cognitive differences between the applicant, the firm and the agent, and the government agency. As a result, the applicant may not be able to achieve the desired results.

Furthermore, the purpose of patent application is not limited to being used as a defense weapon in patent infringement lawsuits or a symbol of corporate image. In fact, patent rights can create value. In addition to obtaining licensing income by granting others the right to implement the patent, the right to exclude infringement and damages can also generate settlement income.

For enterprises, using patent application to protect R&D results has become a necessary and important part of the business process. Some companies believe that patent application is the work of patent companies. As long as they invite contractors to discuss the technical content of the patent application, professional patent companies will be able to write a patent document with accurate technical description, complete disclosure of content, and broad protection scope.

In fact, patent application is not just a collaborative work between enterprises and patent companies. It also requires communication between different departments within the enterprise, especially the repeated communication between the R&D department and the IP department. In the internal patent proposal process of an enterprise, the R&D engineers of the R&D department need to provide relevant technical content disclosure, which may comprise the basic background description of the technology, the shortcomings or problems that need to be improved in the existing technology, and the characteristics of the new technology. In addition, it is also necessary to conduct a preliminary search of the content of the proposed technology in the patent databases of multiple countries to search for similar prior art, in order to promote the internal patent proposal discussion of the enterprise. In many enterprises, the number of R&D personnel far exceeds that of the internal IP department, which increases the workload of the IP department.

However, although most medium-sized and large enterprises currently have relevant patent proposal systems, in practice, due to the professional differences between the R&D department and the IP department, it will generate huge communication time costs, ranging from a few days to several months. The R&D department is very familiar with the technology, but the content required for the patent proposal (patent disclosure document) often cannot meet the requirements of the IP department. On the contrary, when the IP department discusses with the R&D department based on the prior art search report, it is often unable to describe the differences in detail so that the R&D department can see at a glance. Therefore, the discussion progress of the internal patent proposal (patent disclosure document) of the enterprise consumes a lot of labor and time costs. If the enterprise internally produces pictures and even claims, the patent disclosure document generally takes at least a few days to several weeks. Since most enterprises outsource the services of drafting the patent specification and submitting the patent to third-party patent trademark firms or law firms, if there is no patent disclosure document, the repeated technical communication for R&D personnel is tantamount to generating more communication and understanding costs, resulting in delayed patent application time and affecting the rights and interests of enterprise technology protection.

In addition, for small and medium-sized enterprises and start-ups without an IP department, patent search is completely entrusted to third-party patent trademark firms or law firms to assist in the process. However, due to the lack of any patent proposal (patent disclosure document), most of them are conducted through presentations or interviews. Such a mode often makes the inventor spend a lot of time and effort on technical communication. Compared with medium-sized enterprises, the communication and understanding costs between each other in the process are even more staggering.

However, there are already a number of search technologies and search platforms available to help users reduce their workload.

As disclosed in Chinese application number CN201610297330.0, a patent writing assistance system comprises: a disclosure template generation module for generating a template for writing a disclosure document with multiple columns. A disclosure input module for inputting the content of the disclosure document in the corresponding columns of the template to generate a disclosure document. A content identification and extraction module for identifying and extracting the content in the disclosure document (patent disclosure document) in each column. An associated retrieval module connected to an external database server for selecting the extracted content from the content identification and extraction module and associating it with the external database server to retrieve data related to the extracted content from the external database. A copy and storage module for copying and storing the data from the external database. A file generation module for generating a file in the default format with the copied data.

However, the aforementioned chinese application number CN201610297330.0 has several shortcomings. Its main feature is to reduce the time of manual keyword search by having the writer input technical-related content in the corresponding fields, modularizing the input text, and then extracting keywords from the modularized text according to different fields. The keywords are then searched separately for each keyword. The final results are provided to the writer for reference. However, the actual time savings for writing the draft, analyzing and comparing, or communication between different departments in the enterprise is relatively limited. It is also limited to text and cannot assist in generating diagrams.

As disclosed in Taiwanese application number TW097119308, a system for generating patent specifications, the system mainly has a patent specification generation method built in, which can be a software or application. The system can generate a patent specification document. The system comprises: a central processing unit for executing the patent specification generation method. A data storage unit connected to the central processing unit, storing the patent specification generation method. An input unit connected to the central processing unit, providing a user interface for users to input related technical disclosure data. A control unit connected to the central processing unit for controlling the system to execute the processing of data related to the patent specification. An output unit connected to the central processing unit, as an output interface for data related to the patent specification; the output unit can also be connected to a printing unit to print the patent specification. A display unit connected to the central processing unit, as an output display interface for the data of the patent specification.

However, the aforementioned Taiwanese application number TW097119308 has several shortcomings. It requires the input of corresponding text in the corresponding fields. It is mainly through the use of some common terms in patent specifications, similar to the fill-in-the-blank method, to generate the specification text. However, the text entered must meet the internal specifications, otherwise the generated sentences will appear ungrammatical. It is not easy for ordinary users to get started, which is equivalent to users generating the manuscript themselves, which still takes a lot of time. It also does not solve the problem of communication documents for patent disclosure before application, and it is also limited to text and cannot assist in generating diagrams.

As disclosed in U.S. application Ser. No. 17/745,671, in a specific embodiment, an assistant system can assist users in obtaining information or services. The assistant system can allow users to interact with the assistant system through user input of various modes (such as audio, speech, text, image, video, gesture, movement, location, direction) in a state-based and multi-round conversation to receive help from the assistant system. As an example, but not limited to, the assistant system can support single-mode input (such as only voice input), multi-mode input (such as voice input and text input), mixed/multi-mode input, or any combination thereof. The user-provided user input may be associated with a specific assistant-related task and may comprise, for example, a user request (such as a request for information or the execution of an action), a user interaction with an assistant application associated with the assistant system (such as selecting UI elements by touching or gesturing), or any other type of suitable user input that the assistant system can detect and understand (such as user movements detected by the user's client device). The assistant system can create and store a user profile, which comprises personal information and contextual information associated with the user. In a specific embodiment, the assistant system can use natural language understanding (NLU) to analyze user input. This analysis can be based on the user's user profile, to obtain a more personalized and context-aware understanding. The assistant system can analyze and parse entities associated with the user input based on the analysis. In a specific embodiment, the assistant system can interact with different agents to obtain information or services associated with the parsed entities. The assistant system can generate a response to the user about the information or service by using natural language generation (NLG).

However, the aforementioned U.S. application Ser. No. 17/745,671 has several shortcomings. The previous case uses natural language understanding and natural language generation to analyze the text entered by the user, generate corresponding reaction actions or responses, and realize it through a “voice assistant”. However, it is only applied in daily life, and the language used or trained in the background data is very different from the legal terms of intellectual property (patents and trademarks) in terms of words and grammar. It is a horizontally trained model, and the accuracy will be greatly reduced if it is applied to the vertical industry of intellectual property.

As disclosed in the doctoral dissertation of Li Jie-sheng of the Department of Computer Science at National Taiwan University (Application of Deep Learning in the Field of Patents 10.6342/NTU202100999), the language model training scale is not large enough, and the number of data is not enough, which may cause the training results to be inaccurate. Moreover, there is no vertical deep patent language training. In addition, it generates a summary from the input text, and then generates technical content from the summary, which is very dependent on the accuracy of the input text, and it is easy to generate biased technical content text. In addition, the comparison method used in the paper is text mapping. Although text mapping has many advantages, such as being able to capture the semantic information and contextual relationships of text, it also has some disadvantages, such as: dimension disaster: When the text data is very large, text mapping may lead to high-dimensional vector representations. This high-dimensional representation poses a challenge to computation and storage. Semantic discrimination difficulty: Although text mapping can capture some semantic information, for words with ambiguity or context dependency, it may not be able to fully reflect their semantics. At the same time, the semantic similarity between different texts may also be difficult. Training data requirements: Text mapping methods typically require a large amount of labeled training data to learn the vector representations of words and text. Obtaining large-scale and high-quality labeled data can be a time-consuming and expensive task. Vocabulary maintenance: Text mapping methods map words to vector spaces, but in actual applications, they may encounter problems with new vocabulary, spelling errors, or other word variants. This may require vocabulary maintenance and updating to ensure the correctness of the model. This paper is trained with BERT and 2.0, which has certain limitations. It still cannot solve the communication problem between inventors and patent practitioners.

In addition, the ChatGPT 3.5 and 4.0 natural language processing (NLP) models developed by OpenAI are a type of autoregressive language model trained using human feedback reinforcement learning (RLHF). It is mainly used to handle customer service conversations, story creation, translation, grammar correction, writing poems, lyrics, text editing, and even writing software programs. If an inventor uses ChatGPT to generate patent disclosure documents through dialogue, it cannot directly produce accurate patent industry content, nor can it produce related diagrams such as the patent process. For inventors, it can only handle chat robots for consulting patent regulations. In addition, through the patent-related search of GPT, only the correct patent certificate number will be produced, but the correct case name and patent diagram will not be produced, as shown in FIGS. 1 and 2. For patent practitioners, it still needs to be repeatedly proofread, which wastes more time. Therefore, it is even more necessary to have a deep learning intellectual property vertical domain and a language model with industry accuracy to assist in processing patent disclosure documents and patent search systems to solve this problem.

Existing patent drafting tools, such as Patent theory, PowerPatent, and Rowan, can help with the drafting of patent documents. Professional practitioners can provide necessary assistance or editing functions during the drafting process, which can help to reduce the error rate of the completed patent specification, such as maintaining consistency of nouns, and even providing writing suggestions or generating content for reference. This can also improve the efficiency of drafting patent specifications.

However, these existing tools still have some shortcomings. These tools are designed for professional practitioners in the intellectual property industry. That is, the main target users of these tools are engineers who already have some experience in drafting patent specifications. These tools are only in a supporting role. Therefore, for relatively inexperienced company and enterprise researchers, using these tools cannot actually help them solve problems. The operation of these tools is not intuitive for them, and these tools cannot generate diagrams. For non-professionals such as individuals or small and medium-sized enterprises, these tools cannot generate technical disclosure documents and diagrams.

The above description shows that it is necessary to improve or adjust the existing technology to reduce the threshold for ordinary people to apply for intellectual property rights, and to improve their ability to choose the appropriate application type and produce patent drafts and diagrams for researchers. This will avoid the loss of first-mover advantage for patent applications that are urgent. In view of this, the inventor of this invention has made great efforts to research and create, and finally developed the system and method of this invention.

### SUMMARY OF THE INVENTION

Therefore, in order to achieve the above purpose of this invention, this invention provides an execution method for an intelligent patent type recommendation and draft generation system.

In which a user operates an electronic device, and the processor of the electronic device connects to a server through a network interface controller and executes an application to perform patent type recommendation and draft generation, which at least comprises the following steps:
(S100) The user uses the user interface of the electronic device to cause the processor to execute an input module to receive the input text content.
(S200) The processor executes a semantic analysis module in the application to analyze the text content.
(S300) The semantic analysis module further connects to an industry classification module, a search module, and a database module to classify the text content by industry technology and search for matches in the database module. The matching data is then transmitted to an intellectual property information disclosure module.
(S400) The intellectual property information disclosure module analyzes and summarizes the data and presents the information to the user through the user interface of the electronic device.
(S500) The analyzed and summarized data is also transmitted to a recommendation module. The recommendation module classifies and summarizes the types of intellectual property in the data and displays the recommended types of intellectual property applications in the user interface.
(S600) The user selects the patent type through the user interface.
(S700) The user uses the user interface to cause the processor to execute the input module to receive the input technical description.
(S800) Through a login module, the processor executes the semantic analysis module and a content generation module to generate a summary and a simple diagram.

In particular, after step (S800), the following steps are further comprised:
(S8001) The processor executes the recommendation module to analyze the generated summary content and simple diagram, and provides the recommended patent type to apply for.
(S8002) The intellectual property information disclosure module further evaluates each patent type and generates a patent risk assessment report, which is also presented in the information of the recommended patent type through the user interface.
(S8003) The user selects the patent type to apply for through the user interface. The processor executes the semantic analysis module and the content generation module to generate the patent disclosure document, the claim content, and the patent diagram, and integrates them into a draft by inserting them into a formatted template.

The other purpose of this invention is to propose a system for intelligent recommendation and draft generation to solve the problems existing in the existing technologies mentioned above.

Therefore, in order to achieve the other purpose mentioned above, the system provided by this invention is implemented by providing an electronic device for the user to operate. The electronic device comprises a processor and a network interface controller. A server comprises an application. The processor connects to the server through the network interface controller and executes the application to perform intellectual property diagnosis. The system at least comprises a login module, an order processing module, an input module, a semantic analysis module, an industry classification module, a search module, a content learning module, a content generation module, a database module, a natural language database, a recommendation module, and an intellectual property information disclosure module.

The content generation module also comprises a disclosure document generation unit and a diagram generation unit.

The input module is used to receive the text content and technical description input by the user. The text content and technical description are converted into strings for tagging processing. A string information is sent, and the input language of the string information is recorded in a cache memory.

The semantic analysis module receives the string information and analyzes and segments it through a natural language database. The semantic analysis results are generated and sent.

The industry classification module analyzes the industry category classification code based on the semantic analysis results. It connects to a database module for judgment and generates at least one set of patent classification codes.

The search module performs a matching search based on the at least one set of patent classification codes in a database module and generates data for the matching search results.

The intellectual property information disclosure module receives the data and further performs statistical analysis to generate basic intellectual property information.

The recommendation module also receives the data and classifies and summarizes the types of intellectual property in the data. It generates the recommended types of intellectual property to apply for.

The login module is used by the user to operate the electronic device and verify their identity.

The content generation module also comprises a disclosure document generation unit and a diagram generation unit. It receives and generates the summary content and simple diagram based on the semantic analysis results.

Specifically, when the user selects the patent from the recommended types of intellectual property to apply for, the input module receives the user's input technical description again. The login module completes the identity verification. The semantic analysis module receives the string information about the technical description, analyzes and segments it to generate and send the analysis results of the technical description. The disclosure document generation unit generates the summary content based on the analysis results. The diagram generation unit then generates the simple diagram based on the summary content. The recommendation module analyzes the summary content and simple diagram to generate the recommended type of patent to apply for. The intellectual property information disclosure module evaluates the recommended type of patent to generate a patent risk assessment report. The disclosure document generation unit, the diagram generation unit, and a claim content generation unit generate the patent disclosure document, claim content, and patent diagram based on the patent type, summary content, and simple diagram.

The following is a detailed explanation of the implementation example with a diagram.

### BRIEF DESCRIPTION OF THE DRAWINGS

The technical characteristics of this disclosure will become apparent with the detailed description of preferred embodiments accompanied with the illustration of related drawings.

FIG. 1 is a schematic diagram of the prior art;

FIG. 2 is another schematic diagram of the prior art;

FIG. 3 shows a flow chart of the method of the present invention;

FIG. 4 shows a schematic diagram of the system of the present invention;

FIG. 5 is another schematic diagram of the system of the present invention;

FIG. 6 is another schematic diagram of the system of the present invention;

FIG. 7 to 9 show schematic diagrams of application examples of the present invention;

FIG. 10 is another schematic diagram of the system of the present invention;

FIG. 11 show schematic diagrams of another application examples of the present invention;

FIG. 12 to 18 show flow charts of the method of the present invention;

FIG. 19 to 22 show schematic diagrams of application examples of the present invention.

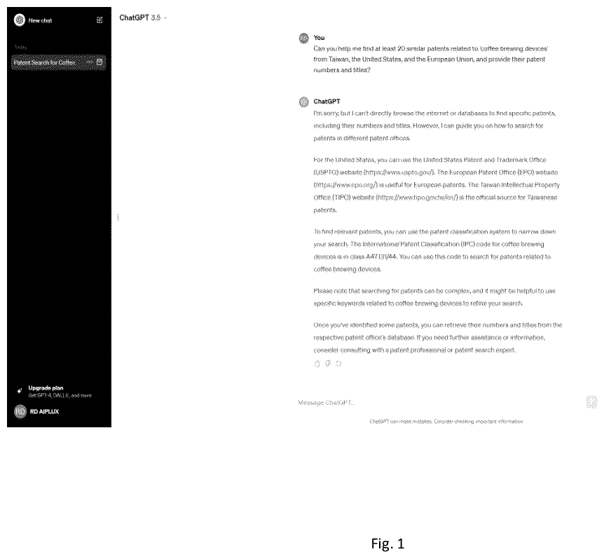

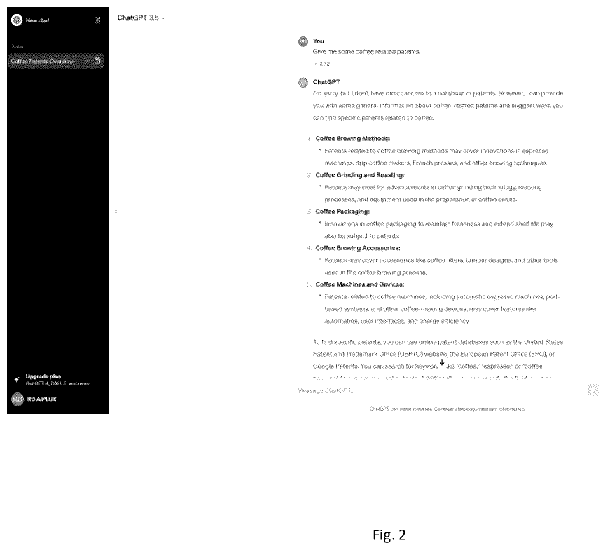

### DETAILED DESCRIPTION OF THE DISCLOSURE

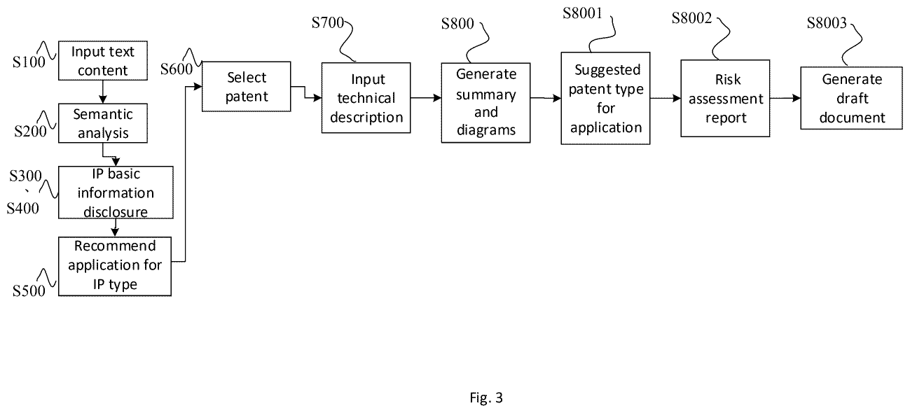

This invention provides an execution method for a system for intelligent patent type recommendation and draft generation. Please refer to FIG. 3. The method of this invention is performed by a user operating an electronic device. The processor of the electronic device is connected to a server through a network interface controller and executes an application to perform patent type recommendation and draft generation. The method at least comprises the following steps:
(S100) The user uses the user interface of the electronic device to cause the processor to execute an input module to receive the input text content.
(S200) The processor executes the semantic analysis module in the application to analyze the text content.
(S300) The semantic analysis module further connects to an industry classification module, a search module, and a database module. The analyzed text content is classified by industry technology and searched for in the database module. The matching data is then sent to an intellectual property information disclosure module.
(S400) The intellectual property information disclosure module analyzes and summarizes the data and presents the information to the user through the user interface of the electronic device.
(S500) The data that has been analyzed and summarized is also sent to a recommendation module. The recommendation module classifies and summarizes the types of intellectual property in the data and displays the recommended types of intellectual property to apply for in the user interface in a sorted order.
(S600) The user selects the patent type through the user interface.
(S700) The user uses the user interface to cause the processor to execute the input module to receive the input technical description.
(S800) The user logs in through a login module and causes the processor to execute the semantic analysis module and a content generation module to generate a summary and a simple diagram.

Specifically, after step (S800), the following steps are further comprised:
(S8001) The recommendation module analyzes the summary and simple diagram to generate the recommended type of patent to apply for.
(S8002) The intellectual property information disclosure module evaluates the recommended type of patent to generate a patent risk assessment report. The patent risk assessment report is also presented in the information of the recommended type of patent through the user interface.
(S8003) The user selects the patent type to apply for through the user interface. The processor executes the semantic analysis module and the content generation module to generate the patent disclosure document, claim content, and patent diagram, and integrates them into a draft by inserting them into a formatted template.

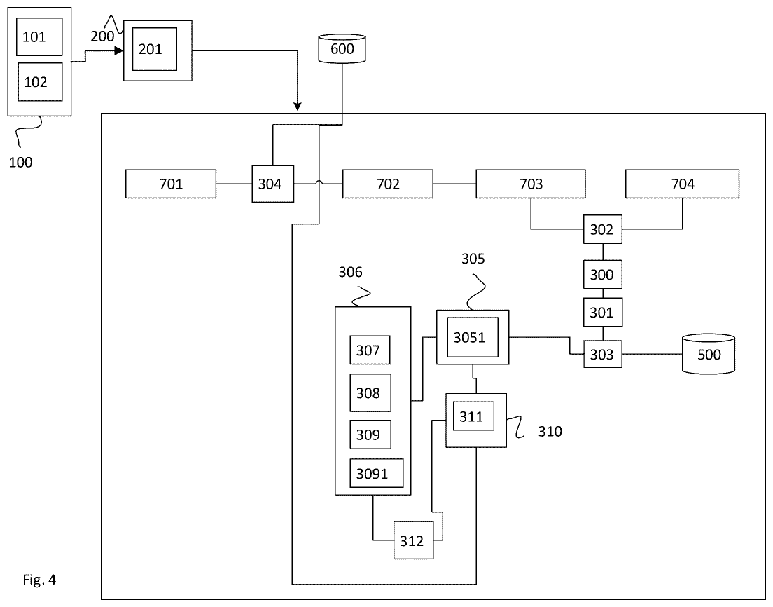

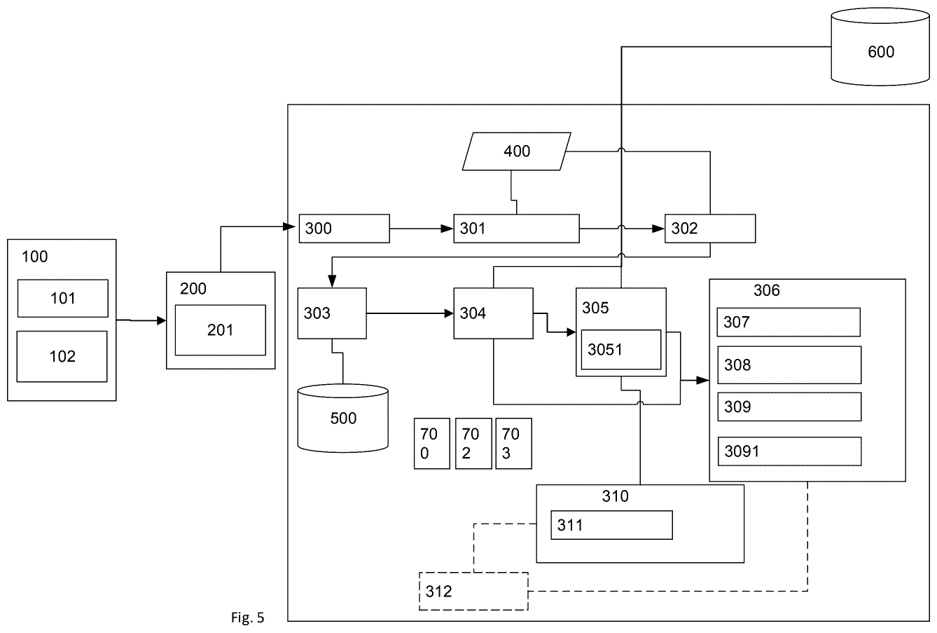

Please refer to FIGS. 4 and 5, which show the schematic diagram of the system of this invention.

The system of this invention is implemented by providing a user with an electronic device 100. The electronic device 100 comprises a processor 101 and a network interface controller 102. A server 200 comprises an application 201. The processor 101 connects to the server 200 through the network interface controller 102 and executes the application 201 to perform intellectual property diagnosis. The system at least comprises a login module 300, an order processing module 301, an input module 302, a semantic analysis module 303, an industry classification module 304, a search module 700, a content learning module 305, a content generation module 306, a database module 600, a natural language database 500, a recommendation module 702, and an intellectual property information disclosure module 703.

The content generation module 306 also comprises a disclosure document generation unit 307 and a diagram generation unit 309.

The input module receives the text content and technical description input by the user. It converts the text content and technical description into strings for tagging processing. It sends a string of information and records the input language of the string of information in a temporary memory.

The semantic analysis module receives the string of information and analyzes and segments it using a natural language database. It generates and sends the semantic analysis results.

The industry classification module analyzes the industry category classification code based on the semantic analysis results. It connects to a database module to determine and generate at least one set of patent classification codes.

The search module performs a matching search in a database module based on the at least one set of patent classification codes. It generates data for the matching search results.

The intellectual property information disclosure module receives the data and further performs statistical analysis to generate basic intellectual property information.

The recommendation module also receives the data and classifies and summarizes the types of intellectual property in the data. It generates the recommended types of intellectual property to apply for.

The login module allows the user to log in to the system.

The content generation module also comprises a disclosure document generation unit and a diagram generation unit. It receives and generates the summary content and simple diagram based on the semantic analysis results.

Specifically, when the user selects the patent from the recommended types of intellectual property to apply for, the input module receives the user's input technical description again. The login module completes the identity verification. The semantic analysis module receives the string information about the technical description, analyzes and segments it to generate and send the analysis results of the technical description. The disclosure document generation unit generates the summary content based on the analysis results. The diagram generation unit then generates the simple diagram based on the summary content. The recommendation module analyzes the summary content and simple diagram to generate the recommended type of patent to apply for. The intellectual property information disclosure module evaluates the recommended type of patent to generate a patent risk assessment report. The disclosure document generation unit, the diagram generation unit, and a claim content generation unit generate the patent disclosure document, claim content, and patent diagram based on the patent type, summary content, and simple diagram.

Specifically, the user uses the electronic device 100 to connect to the server 200 through the network interface controller 102 and execute the application 201. The user can input text or a URL link. The input text can be a description of the company's brand or a technical overview of the company's core products or services. The user can also input the URL link of the official website. If the input module receives a URL link, it will use the network interface controller 102 to extract and read the website content. In detail, the semantic analysis module 303 can then perform semantic analysis on the website content and the input text, and send the analysis results to the industry classification module 304.

The industry classification module 304 analyzes the industry category classification code based on the semantic analysis results. It connects to a database module to determine and generate at least one set of patent classification codes.

The search module connects to the database module 600 based on the at least one set of patent classification codes to perform a matching analysis. It compares the information on the number and types of intellectual property applications in the same or similar industries in the database module 600, and generates data for the search results.

The intellectual property information disclosure module receives the data and further performs statistical analysis to generate basic intellectual property information. It reveals basic intellectual property information, such as: technical value, technical risk, intellectual property time cost and expenditure cost.

The recommendation module also receives the data and classifies and summarizes the types of intellectual property in the data. It generates the recommended types of intellectual property to apply for, such as recommending the application of patents.

This invention provides a system and method for intelligent patent type recommendation and draft generation, including generating system block diagrams, flow charts, and/or illustrative diagrams. In this system, the draft can be automatically generated based on the creativity input by the inventor. In addition, when the inventor publishes or inputs creativity, the system of this invention can perform artificial intelligence semantic reading through natural language processing (NLP) algorithms, and convert the input creativity into programming language to generate system block diagrams, flow charts, or illustrative diagrams. At the same time, the system uses natural language generation (NLG) algorithms to generate a draft including parts such as prior art, core technology description, and technical advantages.

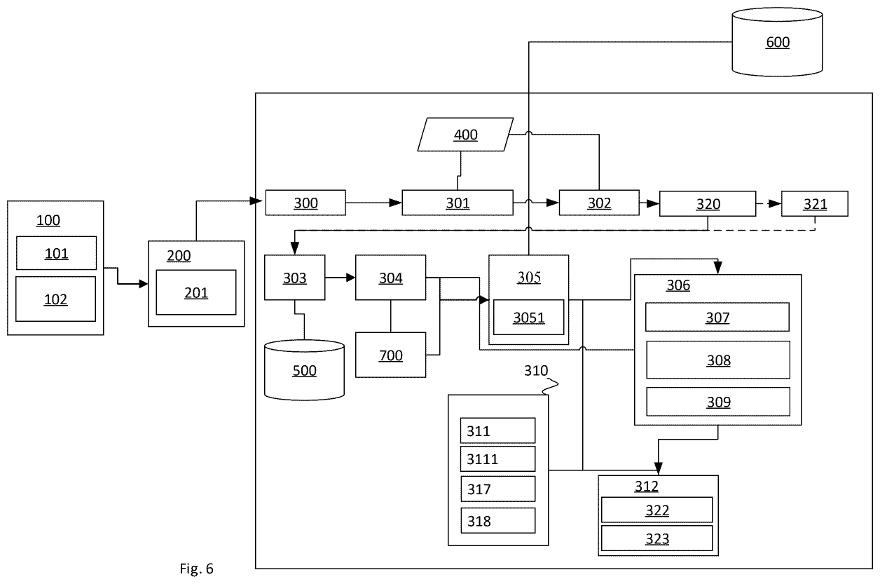

In one embodiment of this invention, the focus is on describing the direct generation of the draft after the user has previously completed the aforementioned intelligent recommendation. However, in this embodiment, the user can also first perform intelligent recommendation and then continue to generate the draft. Please refer to FIGS. 4 to 6 for details. FIG. 6 shows another schematic diagram of the system of this invention.

This invention system is implemented by providing a user-operated electronic device 100, wherein the electronic device 100 comprises a processor 101 and a network interface controller 102. A server 200 comprises an application 201. The processor 101 connects to the server 200 through the network interface controller 102 and executes the application 201 to generate patent diagrams and drafts. The system at least comprises a login module 300, an order processing module 301, an input module 302, a semantic analysis module 303, an industry classification module 304, a content learning module 305, a diagram learning unit 3051, a content generation module 306, a diagram generation unit 309, a search file generation module 310, a graphical search unit 311, a temporary memory 400, a database module 600, and a natural language database 500.

The server 200 can be a cloud server or a local server architecture.

In this embodiment, the creator uses the following server specifications to train and execute the trademark goods item conversion model of this technology:

The processor 101 (CPU) uses a high-performance multi-core processor 101, especially for processing large amounts of data and performing complex calculations. At least one CPU with 16 cores or more is used (such as AMD Ryzen Threadripper or Intel Xeon series). The amount of memory (RAM) can be 64 GB or higher to be able to process the size of the corpus and the size of the word vector model. The network interface controller 102 is a high-speed and stable network connection hardware, especially when used in cloud computing resources or downloading/uploading large amounts of data. The most important graphics processing unit (GPU) uses a high-performance GPU (such as NVIDIA's RTX 30 series or Tesla series) to reduce the training time of the model.

In this case, the server 200 training architecture uses the higher-specification training server mentioned above. When the model is trained and the inference processing is performed, a lower-specification server host can be used. It can also be the cloud or on-premises server host for deploying this system. In this case architecture, the use of server host specifications does not affect the technical features emphasized in this case. Therefore, any server host specification should still fall within the technical scope of this case.

Login module 300: The user operates the electronic device 100 through the login module 300 to verify the identity of the user (login user), and at the same time confirms the identity information.

Order processing module 301: Provides users with the following functions: member registration/login, multi-country patent case order establishment and management, multi-country patent case import, case order query, patent trademark review status confirmation, and account query.

Specifically, users can register and log in to become members of this system, apply for patents, and manage case orders on the system platform, such as: document generation, case acceptance, case submission copy, official notification, etc.

In the order processing module 301, the user generates/creates a new case order, and after the user selects the first target country, the information in the case order is regularly updated to the system's temporary memory 400.

Input module 302, receives the user's input description text or image, converts the description text to a string for tagging processing, and sends the string information and records the input language of the string information in the temporary memory 400.

Specific implementation methods can be described as follows: text preprocessing, tag extraction, stringing, and tagging processing. Text preprocessing is further divided into word segmentation, stop word removal, part-of-speech tagging, and word stemming. Tag extraction first uses pre-defined rules or patterns to extract tags, and uses machine learning models to automatically extract tags. Stringing is to combine the extracted tags into a string, such as “movie#action#comedy”. Tagging processing can be further processed according to needs, such as removing duplicate tags and sorting tags. More specific ways can use natural language processing (NLP) toolkits: such as NLTK, Stanford NLP, HanLP, or machine learning frameworks: such as TensorFlow, PyTorch, scikit-learn.

The semantic analysis module 303 receives string information and analyzes and segments it through a natural language database 500, and generates and sends semantic analysis results.

The industry classification module 304 analyzes the industry category classification code based on the semantic analysis results, connects to the database module 600 for judgment, and generates at least one set of patent classification codes. Among them, the industry category analysis, can be International Patent Category (International Patent Classification), which is classified into A: Human Necessities, B: Performing Operations, Transporting, C: Chemistry, Metallurgy, D: Textiles, Paper, E: Fixed Constructions, F: Mechanical Engineering, Lighting, Heating, Weapons, G: Physics, H: Electricity, or other classification codes such as USPC, JPC, European Classification, and ECLA classification codes.

To perform industry classification analysis on a piece of descriptive text and generate patent IPC classification numbers, the following methods can be used:

Text preprocessing: First, the input descriptive text is preprocessed. This may comprise removing punctuation, stop words, and meaningless characters, and performing lexical normalization (such as stemming or lemmatization).

Feature extraction: Extract meaningful features from the pre-processed text. This can be done using common text feature representation methods, such as bag-of-words (BoW) models or word embeddings. BoW models represent text as the frequency or existence of words, while word embeddings map words to continuous vector spaces.

Classification: The extracted features are then used to classify the text into one or more industry categories. This can be done using a variety of machine learning algorithms, such as support vector machines (SVMs), decision trees, or random forests.

Specifically, the semantic analysis module 303 uses a natural language database 500 to analyze and segment the input string information. The industry classification module 304 then uses the analyzed results to generate at least one set of patent classification codes.

Industry classification model: Build an industry classification model. This can be a machine learning classifier (such as support vector machines, decision trees, or deep learning models) or a rule-based approach. This model will be trained to classify text into the corresponding industry categories.

IPC classification generation: Use the already trained industry classification model to classify the input descriptive text and generate the corresponding patent IPC classification number. IPC (International Patent Classification) is an international standard for classifying patent documents.

Text preprocessing: Preprocess the descriptive text, remove punctuation, convert to lowercase letters, remove stop words, etc.

Feature extraction: Extract features from the pre-processed text. This can be done using common text feature representation methods, such as bag-of-words (BoW) models or word embeddings.

Classification: Use the trained industry classification model to classify the input text into one or more industry categories. This can be done using a variety of machine learning algorithms, such as support vector machines (SVMs), decision trees, or random forests.

Feature extraction: Convert the pre-processed text to a feature vector representation using a bag-of-words (BoW) model. Each word can be considered as a feature, and the frequency of a word in the descriptive text can be used to represent the importance of the word. For example, the following feature vector representation can be obtained:
{“company”: 1, “specialized”: 1, “research”: 1, “development”: 1, “solar”: 2, “generation”: 1, “new”: 1, “material”: 1, “technology”: 2, “design”: 1, “high-efficiency”: 1, “battery”: 1, “convert”: 1, “electricity”: 1, “reduce”: 1, “energy”: 1, “cost”: 1, “environment”: 1, “impact”: 1, “renewable”: 1, “potential”: 1, “widely”: 1, “application”: 1, “household”: 1, “industrial”: 1, “use”: 1}

Industry classification model: Build a trained industry classification model, such as a support vector machine (SVM) or a deep learning model (such as a recurrent neural network or a convolutional neural network), using training data with corresponding labels.

IPC classification generation: Use the trained industry classification model to predict the corresponding patent IPC classification number by inputting the feature vector representation of the pre-processed text into the model. For example, the model may predict that the descriptive text belongs to the solar-related industry category, and the corresponding IPC classification number may be H01L 31/02 (solar cell) or C09K 5/04 (solar material), etc.

Content learning module 305: A large language model that learns the content of the corresponding patent specifications from the database module 600 for different patent classification codes. The schematic learning unit 3051 further learns the schematics in the patent specifications. In other words, the content learning module 305 can learn the writing methods of different types of patent specifications for different patent classification codes, and the schematic learning unit 3051 can learn the correspondence between different types of patent schematics and specifications for different patent classification codes, such as system patents, software patents, mechanical patents, and method patents. The learned specification content can at least comprise the patent name, patent abstract, background technology, patent purpose, patent detailed description, patent claims, patent schematics, and patent marks, even patent defense papers or official documents.

Content generation module 306: This module contains two sub-modules: the disclosure document generation unit 307 and the claim content generation unit 308. Based on the semantic analysis results, the disclosure document generation unit 307 combines the content learning module 305 and the database module 600 to generate a patent disclosure document and claim content. The generated patent disclosure document must comprise at least one technical summary, one prior art content, or a combination of both.

Furthermore, the claim content generation unit 308 analyzes the patent disclosure document again through the semantic analysis module 303, and generates claim content that is converted to technical terms and expressions after content learning.

The content generation module 306 also comprises the component symbol generation unit 3091. The semantic analysis module analyzes the patent disclosure document, segments the words, and breaks down the nouns. It then completes the noun labeling in the content of the patent disclosure document. Next, the patent schematics generated by the schematic generation unit are compared with the patent disclosure document with completed labeling. Finally, the labels are marked on the patent schematics, and the component symbol table is synchronously generated.

The main function of the component symbol generation unit 3091 is to analyze the semantic content in the patent disclosure document, identify and label the component symbols on the patent schematics, and generate a complete component symbol table. This process comprises several key steps:

Semantic analysis: The semantic analysis module first performs in-depth semantic analysis of the patent disclosure document. This comprises using natural language processing (NLP) techniques to segment words and identify key nouns. For example, if the document mentions terms such as “resistor” and “capacitor,” the system will identify these nouns as potential component symbols.

Noun labeling: Next, the component symbol generation unit 3091 will label these identified nouns in the patent disclosure document. This step involves associating each component with a unique identifier. For example, a resistor may be labeled as R1, a capacitor may be labeled as C1, etc.

Here is the translation of the provided description, without adding any information not present in the original text:

Schematic generation and comparison: At this point, the schematic generation unit has generated a patent schematic that comprises all of the mentioned components and their arrangement. Then, the component symbol generation unit 3091 will compare these patent schematics with the patent disclosure document with completed labeling.

Label mapping: After a detailed comparison, the component symbol generation unit 3091 will mark the corresponding labels on the patent schematics. This process is accomplished by mapping the component names and labels in the patent disclosure document to their corresponding positions in the patent schematics. For example, if the “resistor R1” in the file has a corresponding graphical representation on the schematic, the system will mark “R1” next to the graphic.

Synchronous generation of component symbol table: The last step is to generate the component symbol table, which is a list that summarizes all of the component names, labels, and their positions in the schematics in the patent disclosure document. This table makes it easy for readers to quickly locate the position of each component in the schematics and understand their functions and relationships.

To achieve these functions, the component symbol generation unit 3091 uses a series of complex algorithms and data structures. These comprise:

Natural language processing (NLP) algorithms: for text analysis, segmentation, and noun identification.

Image processing techniques: for identifying and mapping component symbols from patent schematics.

Database management systems: for storing and retrieving the component names, labels, and their positions in the files.

In addition, the component symbol generation unit 3091 may also use machine learning techniques to improve its accuracy in identifying and mapping components. For example, by training a model to identify different types of electronic component icons, the system can automatically label and locate these components.

The formulas and algorithms used to implement this process may comprise but are not limited to:

Text analysis formulas: For example, TF-IDF (Term Frequency-Inverse Document Frequency) is used to evaluate the importance of a word for one of the files in a file set or a corpus. TF-IDF(t, d)=TF(t, d)×IDF(t, D), where TF(t, d) is the frequency of word t in file d, and IDF(t, D) is the inverse document frequency, calculated as: IDF(t, D)=log(N/|{d∈D:t∈d}|), where N is the total number of files in the corpus, and the denominator is the number of files that contain word t.

Image processing algorithms: For example, the Hough transform can be used to identify lines and curves in an image. The Canny edge detector can be used to identify edges in an image. The template matching algorithm can be used to match a known pattern to an image.

Image processing algorithms: For example, edge detection techniques can be used to identify the boundaries of components in a schematic. A common method is the Canny edge detector.

Machine learning models: For example, convolutional neural networks (CNNs) can be used to identify and classify different component symbols in a schematic.

Database module 600: Provides users with multiple databases needed for multi-country trademark/patent prior case retrieval in this system, such as: official patent databases of each country or public patent search databases, etc.

Schematic generation unit 309: Analyzes and translates the patent disclosure document or claim content into schematic generation language, generates schematic code corresponding to technical content or claim content through schematic generation language, and then generates schematic corresponding to technical content or claim content through the compilation unit. The patent disclosure document, claim content, and schematic are combined to form a draft.

Specifically, to translate the patent disclosure document or claim content into schematic language, first, the translation module needs to analyze the extracted technical information, understand its meaning, and then, the translation module needs to generate the description of the schematic generation language according to the syntax rules of the schematic generation language. Specifically, the following steps can be used to generate schematic generation language: identify technical concepts, identify technical features, and identify technical relationships.

Identify technical concepts: The translation module first identifies the technical concepts in the technical information. Technical concepts are the basic elements in schematic generation language.

Identify technical features: The translation module then identifies the technical features in the technical information. Technical features are used to describe technical concepts.

Identify technical relationships: The translation module finally identifies the technical relationships in the technical information. Technical relationships are used to describe the connections between technical concepts.

Generated patent schematics can be flow charts, block diagrams, or schematic diagrams. Flow charts represent the steps of a method, block diagrams represent the architecture of system components, and schematic diagrams represent the structure of mechanisms or machines.

For example, if the technical information mentions “has a touchscreen,” the translation module can identify it as a “has” technical feature and a “touchscreen” technical concept. If the technical information mentions “comprises a camera and a processor,” the translation module can identify it as a “comprises” technical relationship, a “camera” technical concept, and a “processor” technical concept.

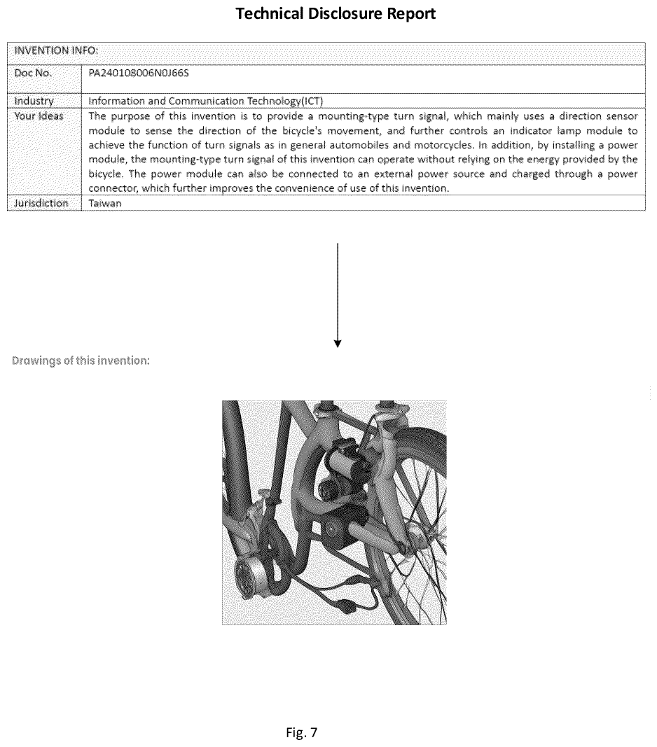

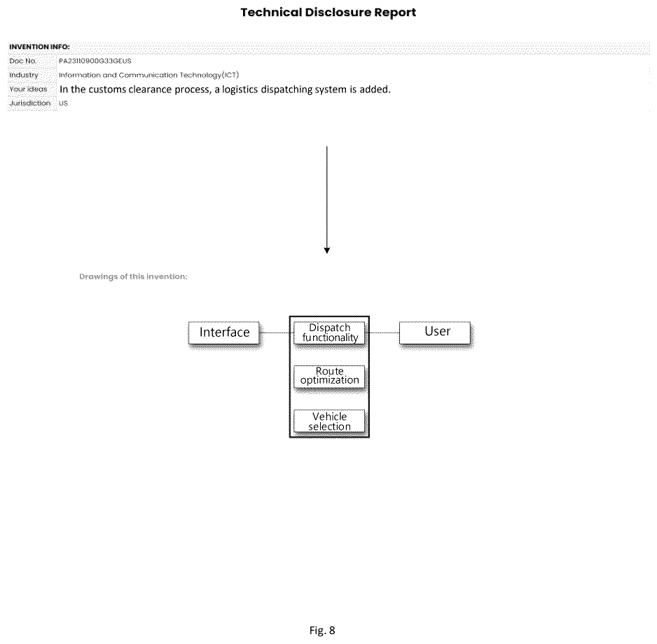

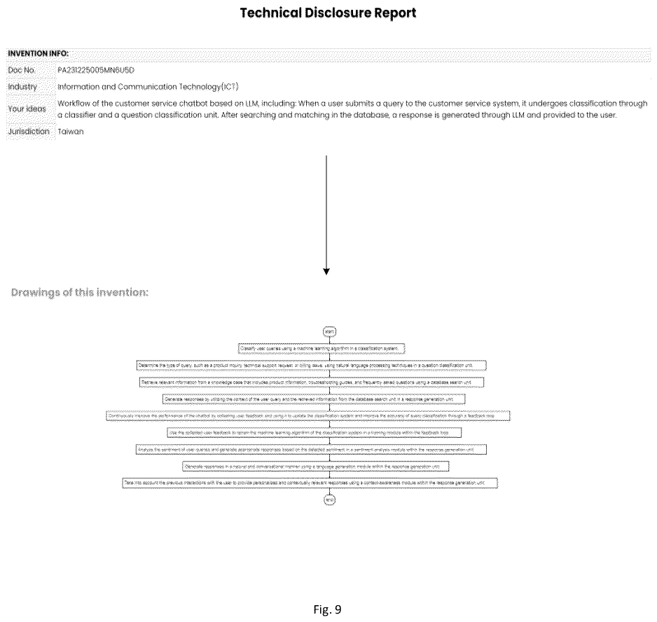

Please refer to FIGS. 7 to 9. The top of FIG. 7 is the technical summary in the patent disclosure document, and the bottom of FIG. 7 is the corresponding schematic diagram generated. The top of FIG. 8 is the technical summary in the patent disclosure document, and the bottom of FIG. 8 is the corresponding system block diagram generated. The top of FIG. 9 is the technical summary in the patent disclosure document, and the bottom of FIG. 9 is the corresponding flowchart generated.

Specifically, the semantic analysis module 303 can perform keyword extraction. Keyword extraction is a natural language processing technique that aims to automatically extract important keywords or phrases from text. The methods can be statistical methods, frequency-based methods, statistical methods, text vectorization methods, or machine learning methods.

Frequency-based methods judge the importance of a word based on its frequency in the text. Common methods comprise TF-IDF (term frequency-inverse document frequency) and term frequency. TF-IDF considers the frequency of a word in the text as well as its importance in the entire corpus, while term frequency only considers the frequency of a word in the text.

Statistical methods analyze the distribution and correlation of words in the text based on statistical models. Common methods comprise mutual information, pointwise mutual information, and chi-squared test. These methods typically require establishing a statistical model between words and text, and then calculating the importance of words based on the model.

Text vectorization methods convert text into vector representations, and then use vector space models to calculate the importance of words. Common methods comprise bag-of-words models, word embeddings, and text vectorization methods (such as TF-IDF vectorization).

Machine learning methods use machine learning algorithms to train models to learn the importance of words from text. Common methods comprise text classification, text clustering, and keyword extraction models. These methods require labeled text data to train the models.

The above can also be implemented by writing a program in a scripting language (such as Python).

Keyword extension is a further function of keyword extraction. It receives the generated keywords and extends them, that is, it finds approximate words or synonyms and compares them to a vocabulary to generate the corresponding synonyms.

Next, please refer to FIG. 6. The system also comprises a language judgment module 320 to determine whether the input language of the string information entered by the user is the same as the official language of the first target country. If the language judgment module 320 determines that the string information is not the same as the official language of the first target country, it translates the string information using a translation module 321. After the patent schematic is finally generated, the translation module 321 is used to translate the language of the patent schematic back to the input language of the string information.

The system of the invention can also further comprise a search file generation module 310 that comprises a graphics search unit 311, a conversion unit 317, and a graphics comparison unit 318. The graphics search unit 311 receives the graphics input by the user and searches in the database module 600 to generate a search file.

After generating the patent disclosure document, claim content, and patent schematic, the user can further search for prior cases through the search file generation module 310, especially for searches for graphics.

Specifically, the graphics search unit 311 first converts the input graphics using the conversion unit 317 to comprise the Vienna classification label, and then converts the graphics to a vector. The graphics comparison unit 318 then compares the graphics with the database module 600 to generate a search file.

To convert a graphic to a vector:

Since graphics are essentially composed of pixels, the brightest can be considered as 1 and the darkest as 0.

Assuming that we do not consider the three primary colors, a 3×3 pixel image can be represented by a vector (1, 0, 1, 0, 1, 0, 1, 0, 1), which is a black and white image.

If we consider the three primary colors, the vector length is expanded three times, becoming (1, 0, 1, 0, 1, 0, 1, 0, 1, 1, 0, 1, 0, 1, 0, 1, 0, 1, 1, 0, 1, 0, 1, 0, 1, 0, 1), which is a color image.

To compare the similarity between two graphics:

The similarity can be calculated using different methods, such as edit distance, cosine similarity, or Jaccard similarity.

The graphics with a similarity score exceeding a set threshold are filtered out. The threshold can be adjusted by the user.

Edit distance is a measure of similarity between strings. It measures the minimum number of operations (insertion, deletion, or substitution) needed to convert one string to another.

It can also be used to approximate the similarity between vectors.

Steps to calculate the similarity between vectors using edit distance:

Vector serialization: Convert each vector to a sequence. For example, a digital vector can be directly converted to a digital sequence. A feature vector can be combined into a string sequence by the name and value of each feature.

Compute edit distance: Use an edit distance algorithm (such as Levenshtein distance) to compute the edit distance between two sequences.

Normalization: Normalize the edit distance to a range of 0 to 1 for ease of comparison. A common normalization method is to divide by the maximum length of the sequence.

Similarity: The similarity between two vectors is represented by (1−normalized edit distance).

The closer the value is to 1, the more similar the vectors are.

Example:

Suppose we have two vectors: vector 1=[1, 2, 3, 4] and vector 2=[2, 3, 1, 4].

Serialization: vector 1->“1234”, vector 2->“2314”

Edit distance: 2 (requires two operations: swapping “1” and “3”)

Normalization: 2/4=0.5

Similarity: 1−0.5=0.5

Therefore, the similarity between these two vectors is 0.5, which indicates that they have a certain degree of similarity.

Cosine similarity: Cosine similarity is a method for measuring the directional similarity between vectors. It can be used to estimate the similarity between vectors.

The principle is to calculate the cosine of the angle between two vectors. The closer the angle is to 0, the more similar the vectors are, and the cosine value is also closer to 1.

Steps to calculate the similarity between vectors using cosine similarity:

Vector preprocessing: Ensure that the two vectors have the same dimensions.

Normalize the vectors (e.g., make their lengths 1) to eliminate the effects of vector length differences.

Inner product calculation: Calculate the inner product between two vectors, which is the sum of the products of corresponding elements in each dimension. The inner product reflects the correlation of the two vectors in terms of direction.

Vector length calculation: Calculate the length of each vector, which is the sum of the squares of the elements in each dimension, then take the square root. The vector length reflects its overall size.

Cosine similarity calculation: Divide the inner product by the product of the lengths of the two vectors to obtain the cosine similarity of the two vectors.

Similarity analysis: Cosine similarity ranges from −1 to 1.

Cosine similarity close to 1 indicates that the directions of the two vectors are very similar, and the similarity is very high.

Cosine similarity of 0 indicates that the vectors are orthogonal, and they are completely dissimilar.

Cosine similarity close to −1 indicates that the directions of the two vectors are opposite, and they are extremely dissimilar.

Preprocessing: The two vectors have the same dimensions, so no further processing is required.

Inner product calculation: 2*4+3*6+4*8=62.

Vector length calculation: sqrt(2\hat{ }2+3\hat{ }2+4\hat{ }2)=sqrt(29), sqrt(4\hat{ }2+6\hat{ }2+8\hat{ }2)=sqrt(100)

Cosine similarity calculation: 62/(sqrt(29)*sqrt(100))≈0.906

Conclusion: The cosine similarity of the two vectors is close to 0.9, indicating that the directions of the two vectors are very similar, and the similarity is very high.

Jaccard similarity: Jaccard similarity is a method for measuring the similarity between vectors.

The principle is to calculate the ratio of the number of identical elements between two vectors. The higher the ratio, the more similar the vectors are, and the higher the Jaccard similarity is.

Steps to calculate Jaccard similarity:

Preprocessing:

Ensure that the two vectors have the same dimensions.

Normalize the vectors (e.g., make their elements sum to 1) to eliminate the effects of vector length differences.

Compute intersection: Calculate the number of identical elements between the two vectors.

Compute union: Calculate the number of all elements in the two vectors.

Compute Jaccard similarity: Divide the intersection by the union to obtain the Jaccard similarity of the two vectors.

Jaccard similarity analysis:

Jaccard similarity ranges from 0 to 1.

Jaccard similarity close to 1 indicates that the two vectors are completely identical, and the similarity is very high.

Jaccard similarity of 0 indicates that the two vectors are completely different.

Example:

Suppose we have two vectors: vector 1=[1, 2, 3, 4] and vector 2=[1, 3, 4, 5].

Intersection: 3

Union: 5

Jaccard similarity: 3/5=0.6

Therefore, the Jaccard similarity of the two vectors is 0.6, indicating that the two vectors are somewhat similar.

Furthermore, the system also comprises a case processing module 312, which executes the case orders of the system, generates and converts them into patent application documents that comply with the regulations. The system further comprises a cross-country conversion module 324 that can execute the conversion of patent application documents across countries, and even executes the function of connecting the system case orders with third-party electronic payment.

The case processing module 312 further comprises a specification generation unit 322 and an application form generation unit 323. The specification generation unit 322 receives the patent drawing and patent disclosure document and generates implementation mode text through the disclosure document generation unit 307 based on the claim content. Then, the claim content is adjusted based on the implementation mode text, and finally, the abstract content, prior art content, implementation mode text, claim content, and patent drawing content are applied to the formatting template to generate a draft.

The application form generation unit 323 captures the identity information of the user logged in and authenticated and brings it in as application data, or the user operates the electronic device 100 to directly input the application data in the field and is received by the input module 302. The application data is then generated by applying the formatting template to generate the application form.

After generating the specification file and application form, the user can operate the electronic device 100 to execute the case processing module 312 to submit the application online or to manage the case. The submission can be made by the user to the official agency, or by the agency that provides the system, especially for different application forms and file formats in different countries.

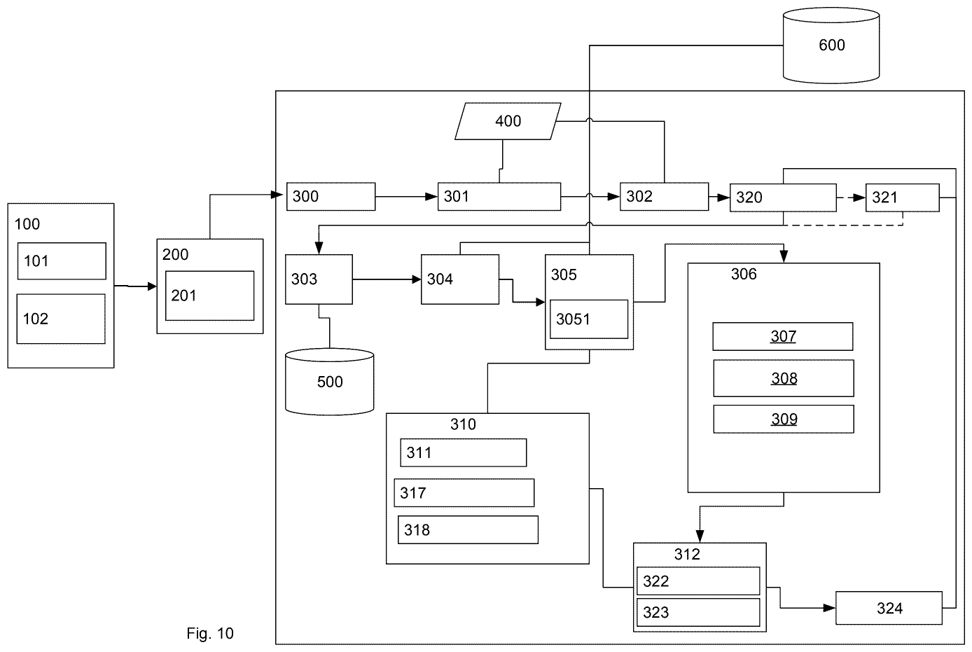

Please refer to FIG. 10 for another schematic diagram of the invention system. The system also comprises a cross-country conversion module 324. After the user generates the specification file and application form, the cross-country conversion module 324 can be used to select a second target country to protect the idea by applying for a patent in different countries.

After the user selects the second target country, the language judgment module 320 will first determine whether the input language of the string information is the same as the official language of the second target country. If not, the patent disclosure document and patent drawing will be translated into the official language of the second target country through the translation module 321. Then, the specification file and application form will be translated into the official language of the second target country and then formatted.

Alternatively, the language judgment module 320 can directly determine whether the language of the specification file and application form is the same as the official language of the second target country. If the same, the specification file and application form can be directly formatted to fit the official file format of the second target country. If not, the specification file and application form will be translated into the official language of the second target country through the translation module 321 and then formatted.

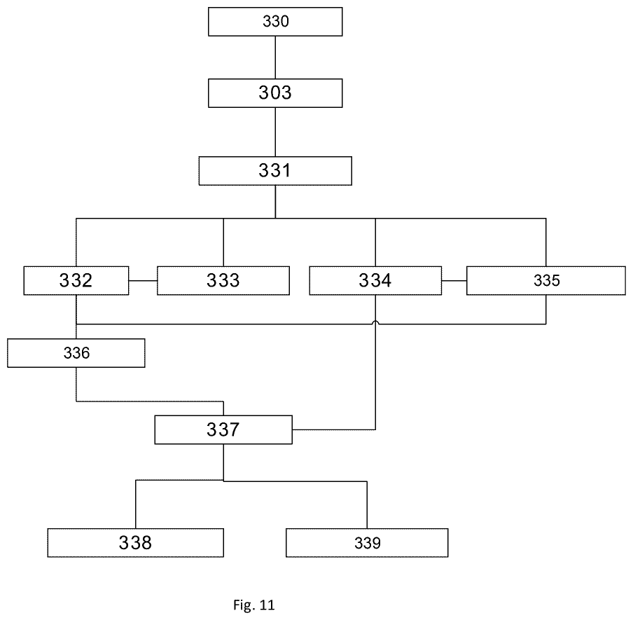

In another embodiment of the invention, the system is further combined with FIG. 11, and comprises: data reception module 330, semantic analysis module 303, keyword extraction module 331, search module 332, IPC analysis module 333, text generation module 334, content learning module 305, keyword extension module 335, document classification module 336, automatic writing module 337, search report generation module 338, and disclosure document generation module 339.

The data reception module 330 can comprise a login module 300, an order processing module 301, and an input module 302. The login module 300 allows the user to authenticate their identity through the electronic device 100 and confirm their identity and identity information. The order processing module 301 provides users with functions such as member registration/login, multi-country patent and trademark case order creation and management, multi-country patent case import, case order inquiry, patent review status confirmation, and account inquiry. The input module 302 receives the descriptive text or images entered by the user, converts the descriptive text to a string for labeling, and sends the string information and records the input language of the string information in the temporary memory 400.

The semantic analysis module 303 receives the string information and analyzes and segments it through a natural language database 500, generating and sending the semantic analysis results.

The keyword extraction module 331 segments and extracts keywords based on the input content, generating multiple keywords.

Specifically, keyword extraction is a natural language processing technique that aims to automatically extract important keywords or phrases from text. The methods can comprise but are not limited to statistical methods, frequency-based methods, statistical methods, text vectorization methods, or machine learning methods.

Frequency-based methods use the frequency of words in the text to determine their importance. Common methods comprise TF-IDF (term frequency-inverse document frequency) and term frequency. TF-IDF takes into account the frequency of words in the text as well as their importance in the entire corpus, while term frequency only considers the frequency of words in the text.

Statistical methods use statistical models to analyze the distribution and correlation of words in the text. Common methods comprise mutual information, pointwise mutual information, and Chi-squared test. These methods typically require building a statistical model between words and text, and then calculating the importance of words based on the model.

Text vectorization methods convert text to vector representations, and then use vector space models to calculate the importance of words. Common methods comprise bag-of-words models, word embeddings, and text vectorization methods such as TF-IDF vectorization.

The keyword extraction module 331 can use any of the above methods to extract keywords from the input text. The specific method used depends on the application requirements.

Machine learning methods use machine learning algorithms to train models to learn the importance of words from text. Common methods comprise text classification, text clustering, and keyword extraction models. These methods require labeled text data to train the models.

The above can also be executed by writing a program in a scripting language (such as Python).

The search module 332 comprises a graphic search unit 311, a transformation unit 317, and a graphic comparison unit 318. The graphic search unit 311 receives the graphics entered by the user and searches in the database module 600 to generate a search file. After the graphic search unit 311 receives the input graphics, it first passes through the transformation unit 317 to convert the graphics and bring in the Vienna classification label, and at the same time converts the graphics to a vector. Then, the graphic comparison unit 318 compares the graphics in the database module 600 to generate a search file.

The IPC analysis module 333 can be the industry classification module 304, which analyzes the industry category classification code of the input text and connects the database module 600 to determine and generate at least one set of patent classification codes.

The text generation module 334 can comprise the content generation module 306, the search file generation module 310, and even further comprise the specification generation unit 322 and the application form generation unit 323. Among them, the content generation module 306 comprises the illustration generation unit 309, and the search file generation module 310 can be the above search module 332.

The content generation module 306 receives and generates technical content based on the semantic analysis results combined with the content learning module 305. The illustration generation unit 309 forms the patent drawing.

The keyword extension module 335 receives the keywords generated by the keyword extraction module 331 and extends them, that is, finds approximate words or synonyms, and connects to a vocabulary table to compare and generate at least one synonym.

The document classification module 336 can classify all case files created by the user, such as attaching specific classification labels, whether the case under construction belongs to a disclosure document or a search file, and whether it belongs to a patent or trademark.

Furthermore, the document classification module 336 can also be used to classify the approximate drawings searched by the graphic search unit 311 in the database module 600. After calculating the similarity, the approximate drawings are classified according to the similarity, such as: those with a similarity above the first risk value are classified as high-risk areas, those between the first and second risk values are classified as medium-risk areas, and those below the second risk value are classified as low-risk areas.

The automatic writing module 337 can be integrated with the content generation module 306 and the content learning module 305. By combining the content learning module 305 and the content generation module 306, the automatic writing module 337 can automatically generate the text required for the corresponding report.

The search report generation module 338 and the disclosure document generation module 339 further generate the generated text in a modularized table format to produce search files or patent disclosure documents that meet the user's needs. They can also be replaced by the search file generation module 310 and the disclosure document generation unit 307, claim content generation unit 308, and drawing generation unit 309.

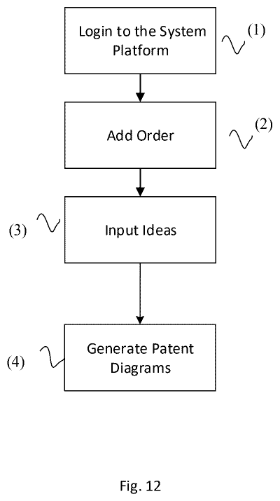

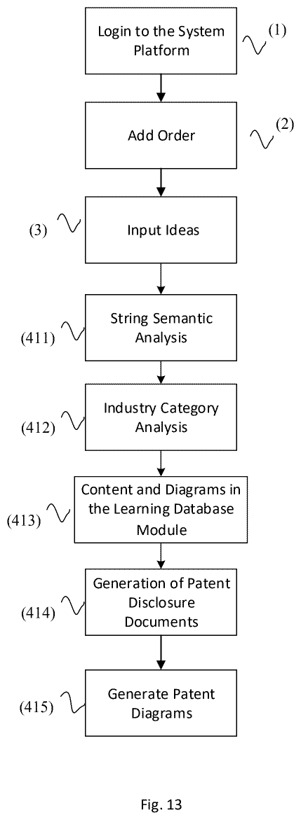

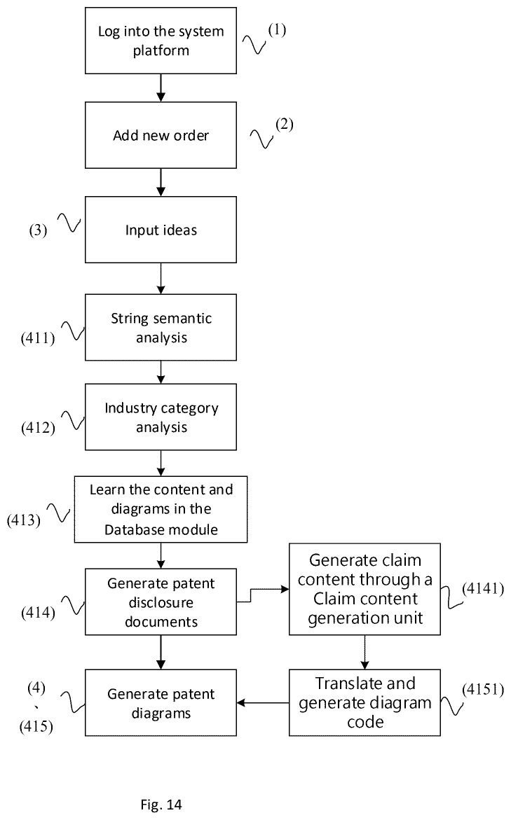

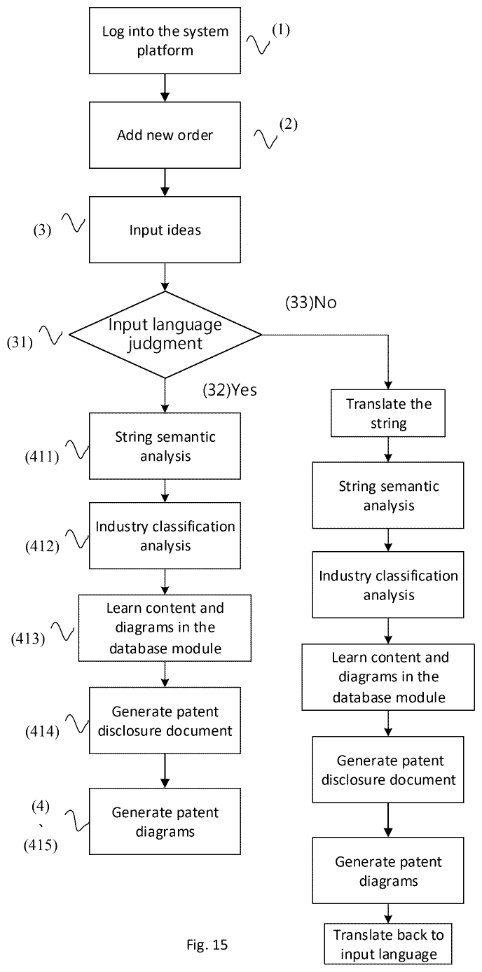

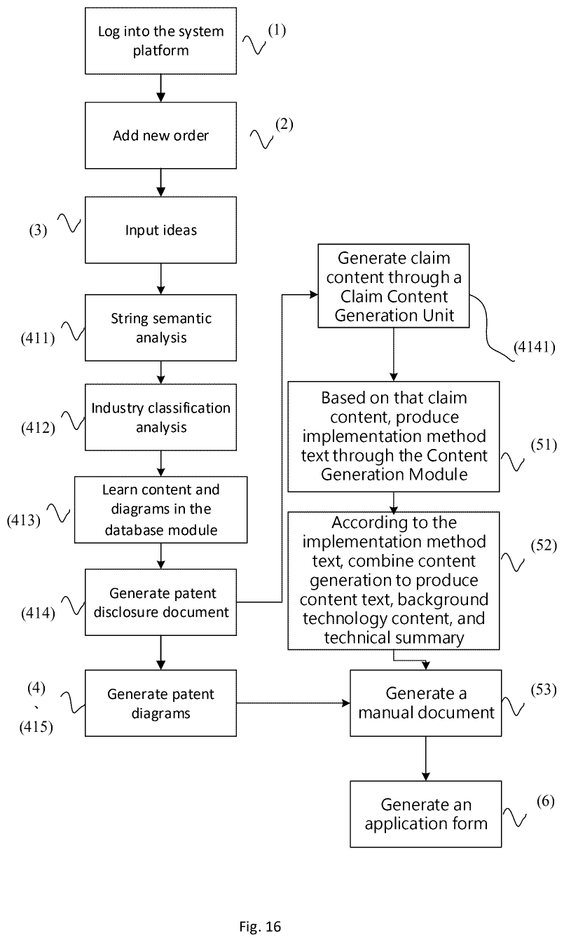

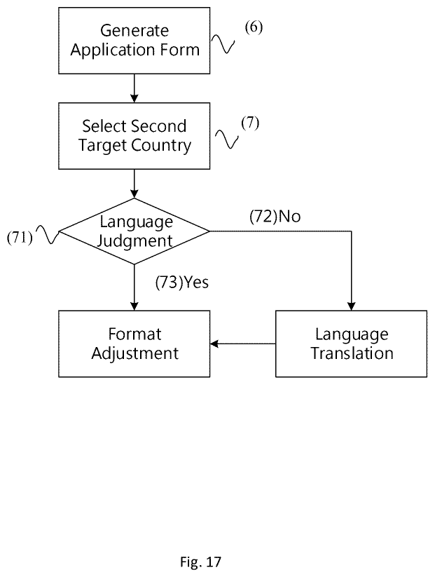

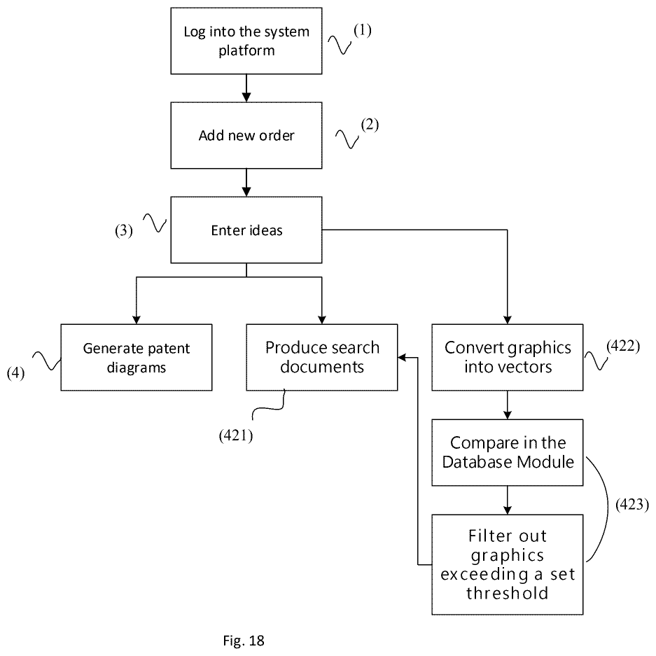

The implementation example of the execution method of the above system is shown in FIGS. 12 to 18, which show the flowchart of the invention method. The user operates an electronic device 100, and the processor 101 of the electronic device 100 connects to a server 200 through a network interface controller and executes an application 201 to generate patent type recommendations and draft generation. At least the following are comprised:
(1) The user logs in to the electronic device 100 and performs identity verification to confirm the user's identity and identity information.
(2) The user adds a case order through the electronic device 100 and selects the first target country. The information in the case order is regularly updated to the temporary memory 400.
(3) The user converts the descriptive text input through the electronic device 100 to a string, performs labeling processing to form string information, and records the input language of the string information in the temporary memory 400.
(4) The semantic analysis module analyzes the string information, the industry classification module classifies the string information, the content learning module learns the content, and the content generation module generates the patent drawing.

In step (4), the following are further comprised:
(411) The semantic analysis module analyzes and segments the string information to generate semantic analysis results.
(412) The industry classification module classifies the string information according to the semantic analysis results to generate at least one set of patent classification codes.
(413) The content learning module learns the contents and drawings of patent specifications from the database module according to the at least one set of patent classification codes.
(414) The content generation module combines the semantic analysis results with the learned content to generate a patent disclosure document.
(415) A patent drawing is generated based on the patent disclosure document.

In step (414), the following are further comprised:
(4141) The patent disclosure document is semantically understood and converted into professional terms and phrases. A claim content generation unit generates claim content.

In step (415), the following are further comprised:
(4151) The patent disclosure document or the claim content is analyzed and translated into drawing generation language. Drawing code corresponding to the patent disclosure document or claim content is generated using drawing generation language. A compilation unit then generates a patent drawing corresponding to the patent disclosure document or claim content.

In step (3), the following are further comprised:
(31) The language judgment module determines whether the input language of the string information is the same as the official language of the first target country.
(32) If so, the semantic analysis is performed directly.
(33) If not, the string information is first translated into the official language of the first target country by the translation module, and then the semantic analysis is performed. After step (4), the generated patent drawing is translated back to the input language of the string information.

In step (4141), the following are further comprised:
(51) The disclosure document generation unit 307 generates implementation method text based on the claim content.
(53) The specification generation unit incorporates the patent disclosure document, the claim content, the implementation method text, and the patent drawing into a template to generate a draft.
(6) The application form generation unit extracts the identity information of the user who has logged in for authentication and enters it as application data, or the user directly enters application data in the field, and generates an application form.

After generating, the case order can be completed and the patent can be submitted for application.

Furthermore, in step (6), the following are further comprised:
(7) The user selects a second target country.
(71) The language judgment module determines whether the language of the specification file and the application form is the same as the official language of the second target country.
(72) If not, the specification file and the application form are first translated through the translation module. The specification generation unit and the application form generation unit then adjust the format of the translated specification file and application form.
(73) If so, the format is adjusted directly.

After the format adjustment is complete, the cross-country patent application conversion is completed, and the application is submitted in the system. The firm will then deliver the application to the official of the second target country.

Furthermore, in step (4151), the following are also comprised:

The semantic analysis module analyzes and judges the patent disclosure document or the claim content. The description of the patent disclosure document or the claim content is judged to be a process method, system architecture, or mechanical mechanism. The graphics generation unit generates the corresponding flowchart, block diagram, or schematic diagram.

Specifically, different compilation units are used to generate flowcharts, system block diagrams, and schematic diagrams. This is because the training data for the compilation units is different.

In the method of the present invention, the following are further comprised in step (4):
(421) A graphics search unit in a search document generation module receives the graphics input by the user and searches in the database module 600 to generate a search file.

In step (421), the following are further comprised:
(422) After the graphics search unit receives the input graphics, it first passes through the transformation unit to transform the graphics and bring in the Vienna classification label, and at the same time transforms the graphics into a vector.
(423) The graphics comparison unit then compares the graphics in the database module and filters out the graphics with a similarity exceeding a set value.

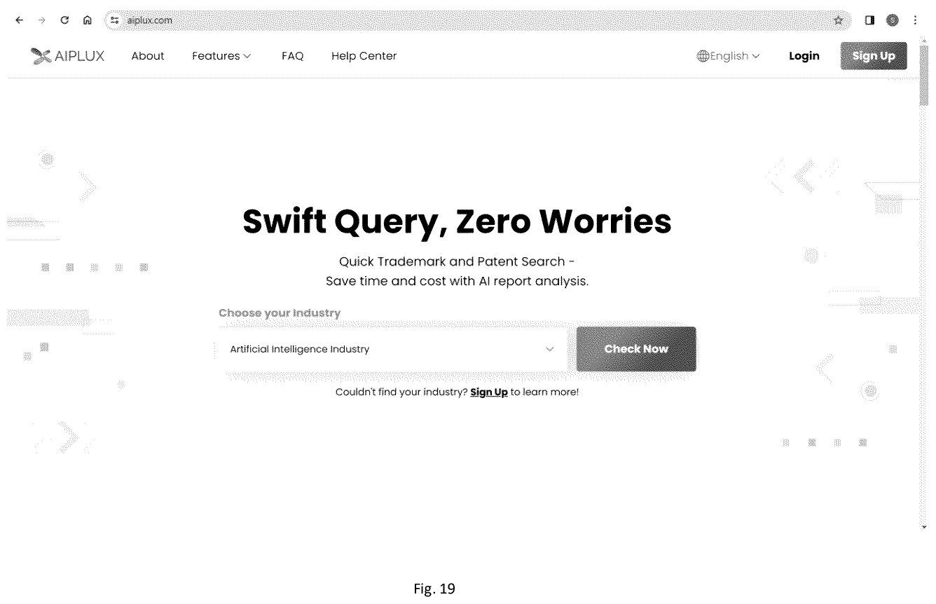

Please refer to FIGS. 19 to 22, which show the application examples of the present invention, the results of the actual operating system (https://aiplux.com/) after entering text or selecting an industry for recommendation and draft generation.

As shown in FIG. 19, the industry category is selected as AI.

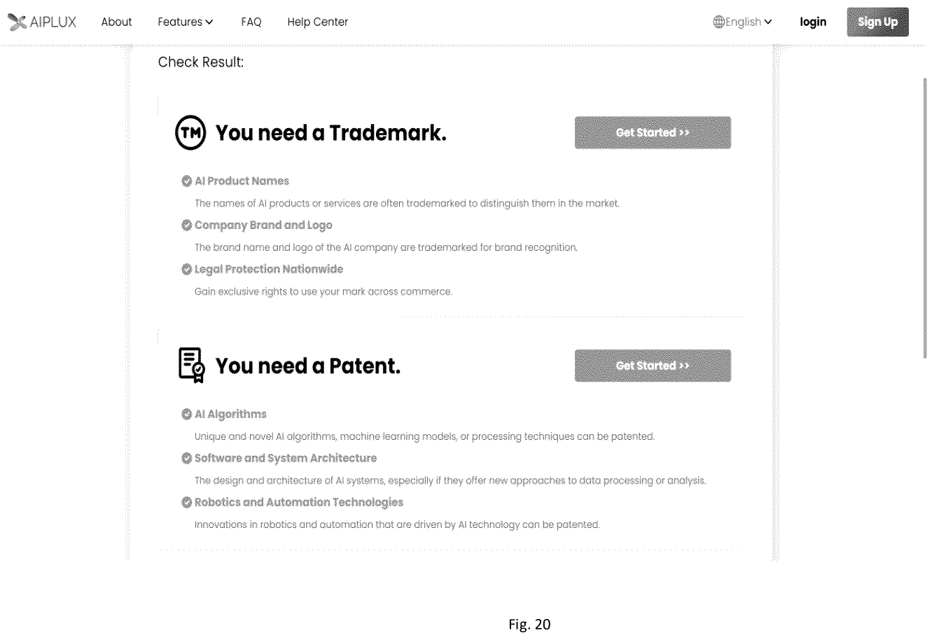

As shown in FIG. 20, the recommended application intellectual property types generated by the present invention after analysis and searching in the database module 600 comprise trademarks and patents, and explain what is suitable for trademarks and what is suitable for patents, and provide examples.

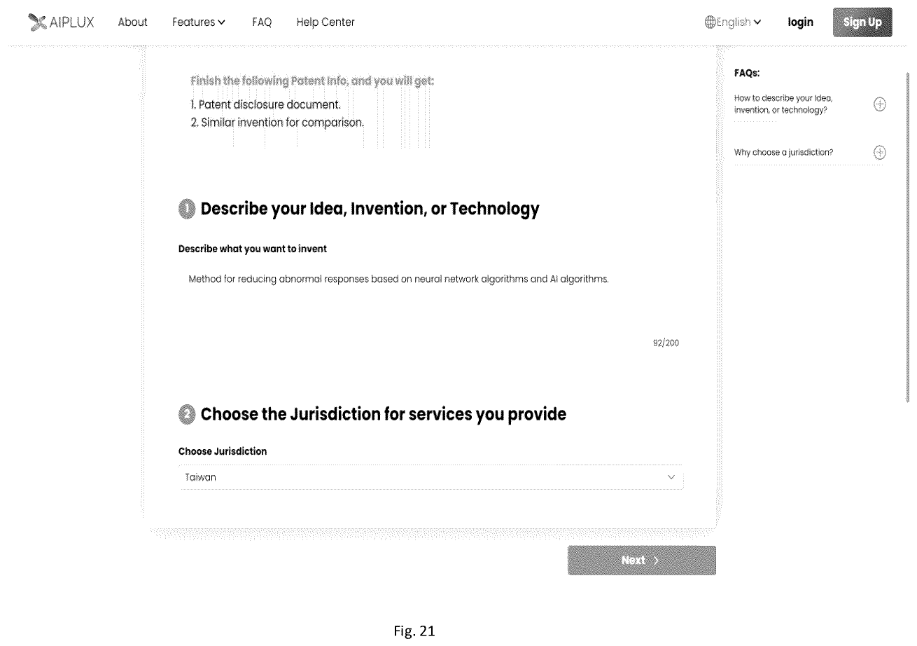

As shown in FIG. 21, the present invention selects a patent after entering more detailed technical descriptions and selecting a country (first target country).

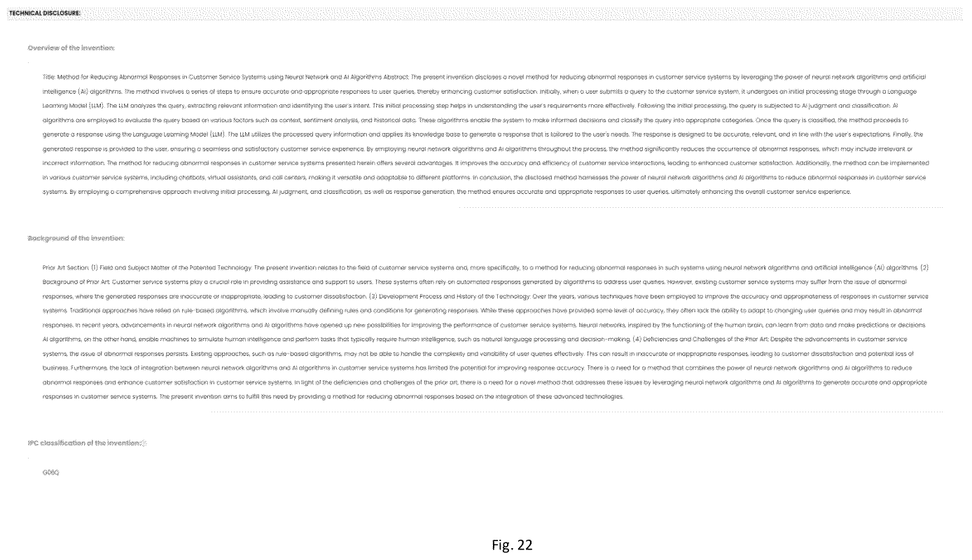

As shown in FIG. 22, the abstract content and prior art content in the draft generated by the present invention.

Finally, the technical features and technical effects that can be achieved by the present invention are summarized as follows:

The present invention can help people understand the professional field of intellectual property rights more easily, especially those who have no idea what kind of intellectual property rights can be applied to protect their own technology. The system provides an intelligent recommendation function.

The present invention can help people who have already decided on the type of intellectual property rights to apply, but still have difficulty in producing application documents (disclosure documents, drafts). The system provides a rapid generation system and method, which can save more time and money.

The present invention can help small and medium-sized enterprises and start-ups without intellectual property departments to resolve the interview mode without any patent proposals (patent disclosure documents). This can reduce the time and effort required for inventors to communicate their technical information, as well as the communication and understanding costs between the two parties during the process.

The present invention provides a complete system and execution method from the initial ideation of technical content to the recommendation of intellectual property protection types, and finally to the generation of drafts and submission of applications. This can greatly reduce the professional threshold for people to enter the application of intellectual property rights to protect their own professional technology.

What is claimed is:

1. A method for intelligent patent type recommendation and draft generation, wherein a user operates an electronic device, and the processor of the electronic device connects to a server via a network interface controller and executes an application program to perform patent type recommendation and draft generation, comprising the following steps at least:
(S100) The user uses the user interface of the electronic device to cause the processor to execute an input module to receive input text content;
(S200) The processor executes a semantic analysis module in the application program to perform semantic analysis on the text content;
(S300) The semantic analysis module further couples with an industry classification module, a search module, and a database module to classify the text content by industry technology, and to search and compare the data in the database module, and to transmit the data matched out to an intellectual property information disclosure module;
(S400) The intellectual property information disclosure module analyzes and statistically analyzes the data and presents the information to the user through the user interface of the electronic device;
(S500) The data analyzed and statistically analyzed is also transmitted to a recommendation module, which classifies and statistically analyzes the types of intellectual property in the data, and displays the recommended types of intellectual property to be applied to the user interface in a sorted order;
(S600) The user selects a patent type through the user interface;
(S700) The user uses the user interface to cause the processor to execute the input module to receive input technical description;
(S800) The user completes the login through a login module, and the processor executes the semantic analysis module and a content generation module to generate summary content and a simplified diagram;
In step (S800) or thereafter, the following are further comprised:
(S8001) The processor executes the recommendation module to analyze the generated summary content and simplified diagram, and to provide a recommended patent type to be applied;
(S8002) The intellectual property information disclosure module further evaluates each patent type and generates a patent risk assessment report, which is presented in the information of the recommended patent type through the user interface at the same time;
(S8003) The user selects the patent type to be applied through the user interface, and the processor executes the semantic analysis module and the content generation module to generate a patent disclosure document, claim content, and patent diagram, and to integrate them into a draft by incorporating a formatted template.

2. An intelligent patent type recommendation and draft generation system, which receives a user terminal through operating an electronic device, the processor of the electronic device connects to a server via a network interface controller and executes an application program for patent type recommendation and draft generation, the system at least comprises:
a data input module for receiving text content and technical descriptions entered by the user, converting the text content and technical descriptions into strings for labeling processing, and sending string information and recording the input language of the string information in a temporary memory;
a semantic analysis module that receives the string information, analyzes and segments the string information through a natural language database, generates and sends semantic analysis results;
an industry classification module that analyzes the industry category classification code for the semantic analysis results, connects to a database module to determine and generate at least one set of patent classification codes;
a search module that searches for the data generated by the at least one set of patent classification codes in a database module according to the at least one set of patent classification codes, and generates data information of the search results;
an intellectual property information disclosure module that receives the data information and further analyzes it statistically, generating basic intellectual property information;
a recommendation module that also receives the data information, and generates the recommended type of intellectual property to be applied according to the type of intellectual property in the data information;
a login module that the user operates the electronic device through the login module to authenticate the identity; and
a content generation module that further comprises a disclosure document generation unit and a diagram generation unit, receiving and generating summary content and a simplified diagram based on the semantic analysis results;
wherein, when the user selects a patent from the type of intellectual property recommended for application, the data input module then receives the user's input technical description again, and completes the identity authentication through the login module, and the semantic analysis module then receives the string information about the technical description, analyzes and segments the string information to generate and send the analysis results of the technical description, the disclosure document generation unit generates the summary content based on the analysis results, the diagram generation unit then generates the simplified diagram based on the summary content, the recommendation module analyzes the summary content and the simplified diagram, and generates the recommended patent type to be applied, the intellectual property information disclosure module evaluates the recommended patent type, generates a patent risk assessment report, and the disclosure document generation unit, the diagram generation unit, and a claim content generation unit generate patent disclosure documents, claim content, and patent diagrams based on the patent type, summary content, and simplified diagram.

3. The An intelligent patent type recommendation and draft generation system, which receives a user terminal through operating an electronic device, the processor of the electronic device connects to a server via a network interface controller and executes an application program for patent type recommendation and draft generation, the system at least comprises:
a login module that the user operates the electronic device through the login module to authenticate the identity;
an order processing module that generates a new case order, and updates the information in the case order to the system's temporary memory on a regular basis after the user selects the first target country;
a data input module for receiving the descriptive text or graphics entered by the user, converting the descriptive text into a string for labeling processing, and sending string information and recording the input language of the string information in the temporary memory;
a semantic analysis module that receives the string information, analyzes and segments the string information through a natural language database, generates and sends semantic analysis results;
an industry classification module that analyzes the industry category classification code for the semantic analysis results, connects to a database module to determine and generate at least one set of patent classification codes;
a content learning module, which is a large language model, further comprises a diagram learning unit, which learns the content and diagrams in the corresponding patent specifications from the database module for different sets of patent classification codes;
a content generation module, which further comprises a diagram generation unit, which receives and generates patent diagrams based on the semantic analysis results combined with the content learning module;
wherein, the content generation module further comprises a disclosure document generation unit and a claim content generation unit, the disclosure document generation unit generates a patent disclosure document based on the semantic analysis results combined with the content learning module, the generated patent disclosure document at least comprises a technical summary, a prior art content, or a combination thereof, the claim content generation unit generates a claim content based on the patent disclosure document combined with the content learning module;
wherein, the patent diagram is generated by the diagram generation unit by analyzing the patent disclosure document or the claim content and translating it into diagram generation language, generating diagram code corresponding to the patent disclosure document or the claim content through diagram generation language, and then generating diagram content corresponding to the patent disclosure document or the claim content through a compiler unit.

4. The system according to claim 3, wherein further comprising a search document generation module, the search document generation module comprising a figure search unit, a transformation unit, and a figure comparison unit, the figure search unit receiving the input figure, first passes through the transformation unit to convert the figure and bring in the Vienna classification label, and simultaneously converts the figure into a vector, and then passes through the figure comparison unit to compare in the database module, and generates a search document.

5. The system according to claim 3, wherein the system further comprises a language determination module, which determines whether the input language of the string information is the same as the official language of the first target country.

6. The system according to claim 5, wherein if the language determination module determines that the string information is not the same as the official language of the first target country, the string information is translated using a translation module, and the language in the patent diagram is translated back to the input language of the string information after the patent diagram is finally generated using the translation module.

7. The system according to claim 3, wherein further comprising a case processing module, the case processing module further comprising:
a specification generation unit, which receives the patent disclosure document and patent diagram, and generates implementation mode text based on the claim content through the disclosure document generation unit, and further applies the formatted template to generate the abstract content, prior art content, implementation mode text, claim content, and patent diagram to generate the draft; and
an application form generation unit, which extracts the identity information of the user through the user login authentication and brings it in as application data, or the user operates the electronic device to directly input the application data in the field by the input module, and the application data is then generated by applying the formatted template to generate the application form;
wherein, after the case processing module generates the specification file and the application form, the user's case order is completed.

8. The system according to claim 4, wherein the transformation unit converts the figure from pixels to vectors.

9. The system according to claim 3, wherein the figure comparison unit, in the process of comparison, uses edit distance, cosine similarity, or Jaccard similarity to calculate the similarity, and filters out figures with a similarity exceeding a predetermined value.

10. The system according to claim 3, wherein further comprises a keyword extraction module that extracts keywords from the input content by word segmentation and keyword extraction, generates multiple keywords, and uses the machine learning algorithm of the content learning module to train the model using the keywords.

11. The system according to claim 6, wherein further comprises an international conversion module, wherein, after the user selects the second target country, the language judgment module first judges whether the input language of the string information is the same as the official language of the second target country. If not, the figure disclosure document and the patent diagram are first translated into the official language of the second target country through the translation module, and then the format is adjusted.

12. An intelligent patent type recommendation and draft generation method, comprising the following steps:
(1) a user logs in to an electronic device and performs identity verification;
(2) the user adds a case order through the electronic device and selects a first target country;
(3) the user inputs description text or a diagram through the electronic device, converts the description text to a string, and performs labeling processing to form string information. The input language of the string information is recorded in temporary memory;
(4) a semantic analysis module analyzes the string information, an industry classification module classifies the string information, a content learning module learns content, and a content generation module generates a patent diagram;
in step 4, the following steps are further comprised:
(411) the semantic analysis module analyzes and segments the string information to generate semantic analysis results;
(412) the industry classification module classifies the semantic analysis results into at least one set of patent classification codes based on the semantic analysis results;
(413) the content learning module learns the content and diagrams in the patent disclosure documents from the database module based on the at least one set of patent classification codes;
(414) the content generation module generates a patent disclosure document by combining the semantic analysis results with the learned content;
(415) a patent diagram is generated based on the patent disclosure document;
in step 414, the following steps are further comprised:
(4141) the patent disclosure document is semantically understood and converted into technical terms and words, a claim content is generated through a claim content generation unit;
(4151) the patent diagram is analyzed and translated into diagram generation language, a diagram code corresponding to the patent disclosure document or claim content is generated using diagram generation language, the diagram code is then generated into a patent diagram through a compiler unit.

13. The method according to claim 12, wherein in step (3), it further comprises:
(31) a language judgment module judges whether the input language of the string information is the same as the official language of the first target country;
(32) if yes, proceed to semantic analysis;
(33) if no, translate the string information into the official language of the first target country through a translation module, and then proceed to semantic analysis, the generated patent diagram is translated back into the input language of the string information in step 4.

14. The method according to claim 12, wherein after step (4141), it further comprises:
(51) a disclosure document generation unit generates implementation mode text based on the claim content;
(53) a specification generation unit incorporates the patent disclosure document, the claim content, the implementation mode text, and the patent diagram into a format to generate a draft;
(6) an application form generation unit extracts the identity information of the user through user login authentication and brings it in as application data, or the user directly inputs the application data in a field, and generates the application form.

15. The method according to claim 14, wherein after step (6), it further comprises:
(7) the user selects a second target country;
(71) a language judgment module judges whether the language of the specification document and the application form is the same as the official language of the second target country;
(72) if no, translate the specification document and the application form through a translation module, the specification generation unit and the application form generation unit then adjust the format of the translated specification document and application form;
(73) if yes, proceed to format adjustment.

16. The method according to claim 12, wherein after step (4), it further comprises:
(421) a search document generation module, including a figure search unit, receives the figure input by the user and searches for it in the database module, and generates a search document.

17. The method according to claim 16, wherein after step (421), it further comprises:
(422) the figure search unit converts the input figure to a vector after receiving the input figure;
(423) the figure search unit compares the figure with the figures in the database module and filters out the figures with a similarity exceeding a predetermined value.
